(19) United States
(12) Patent Application Publication
(10) Pub. No.: US 2007/0205384 A1
(43) Pub. Date: Sep. 6, 2007

(54) Flow Rate Control Apparatus

(75) Inventor: Kenichi Kurosawa, Kashiwa-shi (JP)

Correspondence Address: PAUL A. GUSS;PAUL A. GUSS ATTORNEY AT LAW, 775 S 23RD ST FIRST FLOOR SUITE 2, ARLINGTON, VA, 22202, US

(73) Assignee: SMC Kabushiki Kaisha, Tokyo (JP)

(21) Appl. No.: 11/672,295

(22) Filed: Feb. 7, 2007

(30) Foreign Application Priority Data
Mar. 2, 2006 (JP) 2006-056035

(51) Int. Cl. F16K 47/00; F16K 15/00; B05B 1/14

(52) U.S. Cl. 251/127; 239/558; 137/455

(57) ABSTRACT

A flow rate control apparatus includes a base section, wherein the base section is composed of a plurality of stacked metal plates. The flow rate control apparatus further includes a pressure control section, which regulates pressure of a pressure fluid (gas) that flows through a first passage in the base section, a pressure sensor that detects pressure of the pressure fluid flowing through a second passage, and a flow passage-switching section, including first to third orifices, for throttling the fluid pressure-regulated by the pressure control section so as to have a predetermined flow rate, and which has first to third ON/OFF valves for switching fourth to sixth passages for respectively directing the pressure fluid toward a pressure fluid output port.

### BACKGROUND OF THE INVENTION

1. Field of the Invention

The present invention relates to a flow rate control apparatus, which is capable of obtaining a stable output by highly accurately controlling the flow rate of a pressure fluid.

2. Description of the Related Art

For example, Japanese Laid-Open Patent Publication No. 8-35506 discloses a fluid control unit constructed by stacking a plurality of metal plates, which have flow passages composed of penetrating holes and non-penetrating holes formed perpendicularly with respect to surfaces of the metal plates.

In the case of this fluid control unit, fluid interference areas and flow passages, which are composed of the penetrating and non-penetrating holes, are formed by press working the plurality of metal plates. Further, after respective surfaces of the plates have been processed with grinding grains, the respective metal plates are stacked and joined by means of diffusion joining or brazing joining. Accordingly, it is possible to obtain a small-sized highly accurate fluid element, having highly reliable joined portions and high dimensional accuracy, along with good geometrical shape accuracy.

However, a mechanical driving section is not provided at all in the fluid control unit disclosed in Japanese Laid-Open Patent Publication No. 8-35506. Therefore, when a fluid control circuit is constructed, using a fluid control unit and fluid elements such as a regulator and a sensor, which are connected on upstream and downstream sides of the fluid control unit, it is necessary to perform setting operations for assuring effective matching between the fluid control unit and the fluid elements such as the regulator and the sensor.

Further, control accuracy of the fluid flow rate, which is obtained as an output, is affected in response to the degree of matching between the fluid control unit and the fluid elements such as the regulator and the sensor.

### SUMMARY OF THE INVENTION

A general object of the present invention is to provide a flow rate control apparatus in which a flow passage-switching section and a pressure control section, for controlling the flow rate of a fluid that flows through passages thereof, are provided integrally with a base section composed of a stack, whereby the flow rate of the fluid can be controlled stably and highly accurately.

According to the present invention, a base section, which is composed of a stack, includes a pressure control section, which regulates the pressure of a pressure fluid (for example, a gas) that flows through passages formed in the base section, a pressure sensor, which detects the regulated pressure of the pressure fluid, and a flow passage-switching section, which switches the passages for the pressure fluid that is regulated to have a constant pressure, wherein the pressure control section, the pressure sensor and the flow passage-switching section are provided in a combined form integrally with the base section respectively. Accordingly, unlike the conventional technique, it is unnecessary to perform specialized matching operations. Further, for example, even when the source pressure of an unillustrated gas supply source fluctuates, the flow rate of the pressure fluid can still be controlled highly accurately, so that the pressure fluid can be output with a stable flow rate.

Since the flow passage-switching section and the pressure control section, which control the flow rate of the fluid that flows through the passages, are provided integrally with the stacked base section, accordingly, it is possible to control the flow rate of the fluid stably and highly accurately.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a longitudinal sectional view taken in the axial direction illustrating a flow rate control apparatus according to a first embodiment of the present invention;

FIG. 2 is a circuit diagram of the flow rate control apparatus shown in FIG. 1;

FIG. 3 is a perspective view illustrating a base section that makes up a portion of the flow rate control apparatus shown in FIG. 1;

FIG. 4 is an exploded perspective view illustrating the base section shown in FIG. 3;

FIG. 5 is a magnified longitudinal sectional view illustrating a flow passage-switching section that makes up a portion of the flow rate control apparatus shown in FIG. 1;

FIG. 6 is a magnified longitudinal sectional view illustrating a state in which a valve plug of the flow passage-switching section shown in FIG. 5 is displaced;

FIG. 7 is a longitudinal sectional view illustrating another embodiment, in which a linear solenoid valve is provided in the pressure control section;

FIG. 8 is a longitudinal sectional view illustrating another embodiment, in which a linear solenoid valve is provided in the flow passage-switching section;

FIG. 9 is a longitudinal sectional view illustrating another embodiment, in which linear solenoid valves are provided in the pressure control section and the flow passage-switching section, respectively;

FIG. 10 is a block diagram illustrating a state in which the flow rate control apparatus shown in FIG. 1 is connected to a chamber of a semiconductor manufacturing apparatus;

FIG. 11 is a block diagram illustrating a state in which the pressure fluid output port of the flow rate control apparatus shown in FIG. 1 branches into a plurality of ports to be connected to a chamber;

FIG. 12 is a circuit diagram of the flow rate control apparatus shown in FIG. 11;

FIG. 13 is an exploded perspective view illustrating a base section that makes up a portion of the flow rate control apparatus shown in FIG. 11;

FIG. 14 is a circuit diagram of a flow rate control apparatus according to a second embodiment of the present invention;

FIG. 15 is a circuit diagram in which the pressure fluid output port of the flow rate control apparatus shown in FIG. 14 branches into a plurality of ports;

FIG. 16 is a longitudinal sectional view taken in the axial direction illustrating a flow rate control apparatus according to a third embodiment of the present invention;

FIG. 17 is a longitudinal sectional view illustrating a modified embodiment of the flow rate control apparatus shown in FIG. 16;

FIG. 18 is a longitudinal sectional view taken in the axial direction illustrating a flow rate control apparatus according to a fourth embodiment of the present invention;

FIG. 19 is an exploded perspective view illustrating a base section of the flow rate control apparatus shown in FIG. 18;

FIG. 20 is a partial magnified longitudinal sectional view illustrating a differential pressure sensor of the flow rate control apparatus shown in FIG. 18;

FIG. 21 is a schematic structural view illustrating principles of operation of the differential pressure sensor shown in FIG. 20;

FIG. 22 is a longitudinal sectional view taken in the axial direction illustrating a flow rate control apparatus according to a fifth embodiment of the present invention;

FIG. 23 is an exploded perspective view illustrating a base section of the flow rate control apparatus shown in FIG. 22;

FIG. 24 is, in partial cutout, a magnified view illustrating a rectifying mechanism provided in a third plate;

FIG. 25 is a schematic structural view illustrating functions that are obtained when a rectifying mechanism is not provided; and

FIG. 26 is a schematic structural view illustrating functions that are obtained when the rectifying mechanism is provided.

### DESCRIPTION OF THE PREFERRED EMBODIMENTS

The flow rate control apparatus 10 of the present invention comprises a base section 18, which is composed of a stack having a plurality of metal plates functioning as plates that are integrally stacked and joined, and having a pressure fluid input port 12, a pressure fluid output port 14, and a pressure sensor port 16 formed on the lower surface thereof respectively, a pressure control section 20, which is provided on an upper surface of the base section 18 and which controls a pressure of the pressure fluid that flows through passages formed in the base section 18 (as described later on), and a flow passage-switching section 22, which is provided on the upper surface of the base section 18 adjacent to the pressure control section 20 and which switches the passages that are in communication with the pressure fluid output port 14.

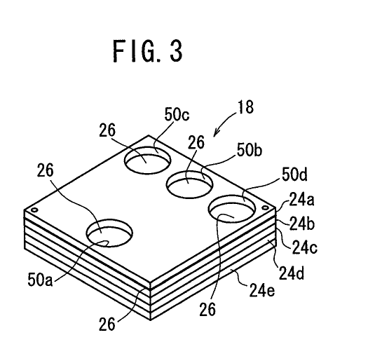

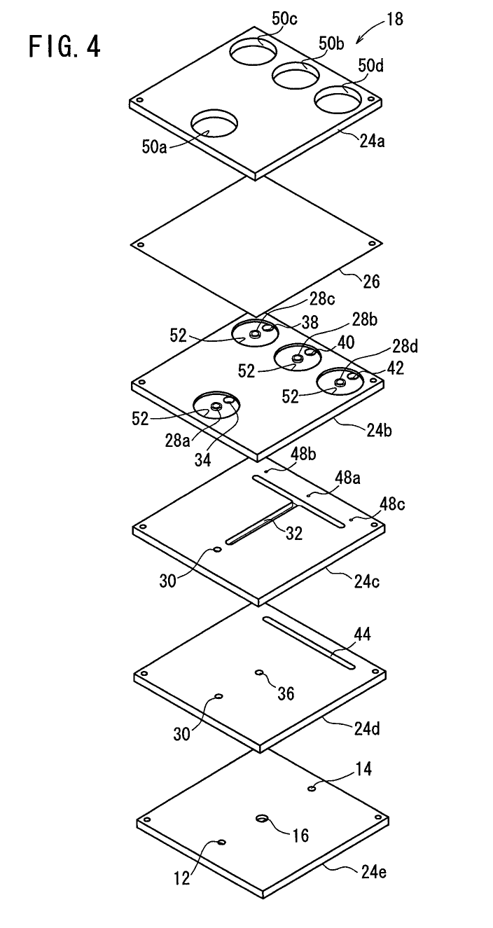

As shown in FIGS. 3 and 4, the base section 18 includes first to fifth plates 24a to 24e, which are composed of a plurality of metal plates having rectangular cross sections, and valve plugs 26 interposed between the first plate 24a and the second plate 24b, which are formed by a thin film diaphragm made of a flexible resin, and further which is disposed in common with respect to the pressure control section 20 and the flow passage-switching section 22 respectively. The first to fifth plates 24a to 24e, which constitute the stack, need not be limited to metal plates. For example, the first to fifth plates 24a to 24e may also be formed from ceramic materials or resin materials. The valve plugs 26, which are formed by the diaphragm, may be constructed from a metal material or a rubber material.

In this arrangement, a plurality of passages (described later on), through which the pressure fluid flows, are formed within the base section 18 by means of penetrating holes and non-penetrating holes. Further, seat sections 28 (28a to 28d), on which the valve plugs 26 are to be seated, are formed by means of annular projections.

The passages include a first passage 30, which communicates between the pressure fluid input port 12 formed on the lower surface of the base section 18 and the pressure control section 20 provided on the upper surface of the base section 18, and further which penetrates in a vertical direction through the stacked second to fifth plates 24b to 24e, a second passage 34, which communicates with the first passage 30 through a gap formed when the valve plug 26 of the pressure control section 20 separates from the seat section 28a, and further which communicates with the flow passage-switching section 22 via a groove 32 having a T-shaped cross section formed in the third plate 24c, a third passage 36, which extends in a vertically downward direction from an intermediate position in the second passage 34, and further which communicates with the pressure sensor port 16, fourth to sixth passages 38, 40, 42 which branch respectively in three directions from a terminal end of the second passage 34, and a seventh passage 44 into which the fourth to sixth passages 38, 40, 42 combine so as to communicate with the pressure fluid output port 14.

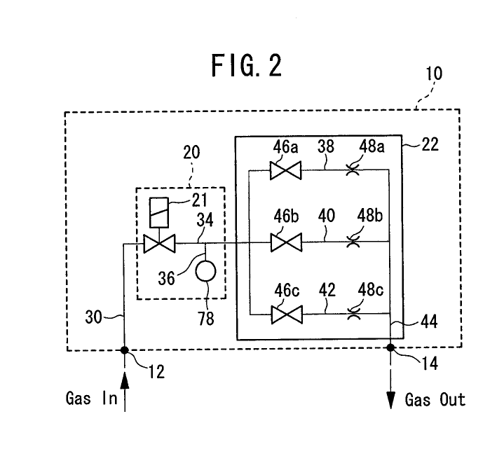

The fourth to sixth passages 38, 40, 42 are provided with first to third ON/OFF valves 46a to 46c, which operate to open and close the respective passages so as to perform passage-switching operations, and first to third orifices 48a to 48c disposed on a downstream side of the first to third ON/OFF valves 46a to 46c, which throttle flow rates of the pressure fluid flowing through the respective passages, thereby providing respective predetermined flow rates (see FIG. 2). In this arrangement, the first to third orifices 48a to 48c function as throttle mechanisms.

Next, detailed explanations shall be made concerning the shapes of the first to fifth plates 24a to 24e, which make up the stack that forms the base section 18, in order from an upper position thereof (see FIG. 4).

The first plate 24a, which is positioned at the upper surface of the base section 18, is formed with a penetrating first connection port 50a having a circular cross section, and penetrating second to fourth connection ports 50b to 50d having circular cross sections, to which the first to third ON/OFF valves 46a to 46c are connected respectively. As described later, a piezoelectric/electrostrictive actuator or a linear solenoid is connected to the first connection port 50a.

The second plate 24b, which is stacked on the lower surface of the first plate 24a, is formed with four circular recesses 52 therein corresponding to positions of the first to fourth connection ports 50a to 50d. Valve plugs 26, which are composed of the sheet-shaped diaphragm as described above, are interposed between the first plate 24a and the second plate 24b. An annular projection, which functions as a seat section 28 for seating the valve plug 26 thereon, is formed at the center of the circular recess 52. A penetrating hole, which functions as the second passage 34 (fourth to sixth passages 38, 40, 42), is formed at a portion disposed adjacent to the annular projection.

In this arrangement, one of the plurality of annular projections forms the seat section 28a for the valve plug 26 of the pressure control section 20 (the adjoining penetrating hole forms the second passage 34). The remaining three form the seat sections 28b to 28d for the valve plugs 26 of the first to third ON/OFF valves 46a to 46c that make up the flow passage-switching section 22 respectively (the adjoining penetrating holes form the fourth to sixth passages 38, 40 and 42, respectively).

The third plate 24c, which is stacked on the lower surface of the second plate 24b, is provided with a groove 32 having a substantially T-shaped cross section, a small hole having a circular cross section, which communicates with the pressure fluid input port 12 and functions as the first passage 30, and first to third orifices 48a to 48c, which throttle the flow rates of the pressure fluid that flows through the seat sections 28b to 28d of the first to third ON/OFF valves 46a to 46c so as to acquire predetermined flow rates, respectively.

The effective cross-sectional areas of the three first to third orifices 48a to 48c may be set to be identical with each other, or set to be different from each other. It is assumed that the effective cross-sectional areas thereof are input beforehand as known values into an unillustrated controller.

The fourth plate 24d includes a small hole having a circular cross section, which functions as the first passage 30 in communication with the pressure fluid input port 12, another small hole having a circular cross section, which functions as the third passage 36 in communication with the pressure sensor port 16, and the seventh passage 44 in the form of a linear groove, respectively.

The fifth plate 24e includes the pressure fluid input port 12, which is composed of a small hole having a circular cross section disposed adjacent to one end thereof, the pressure sensor port 16, which is composed of a hole having a circular cross section disposed at the central portion thereof, and the single pressure fluid output port 14, which is composed of a small hole having a circular cross section disposed adjacent to the other end thereof, respectively.

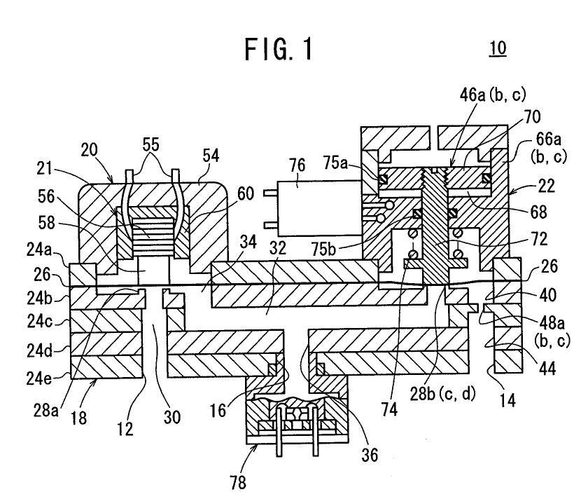

The pressure control section 20 comprises a control valve 21, and a pressure sensor 78 as described later (see FIG. 2). As shown in FIG. 1, the control valve 21 includes a housing 54, which is installed in the circular hole of the first plate 24a of the base section 18, a piezoelectric/electrostrictive element 56, for example, a piezoelectric element composed of a stack of sintered ceramic piezoelectric/electrostrictive materials, which is displaceable as a result of a piezoelectric/electrostrictive effect generated by applying a predetermined voltage to the exposed terminal sections 55 thereof, a connecting member 58 connected to the end of the piezoelectric/electrostrictive element 56, and a holding member 60 formed of a nonconductive material, which holds the piezoelectric/electrostrictive element 56.

The connecting member 58 connected to the piezoelectric/electrostrictive element 56 has a forward end thereof that abuts against the diaphragm, which functions as the valve plug 26. When the piezoelectric/electrostrictive element 56 is displaced, a spacing distance (gap) between the valve plug 26 and the seat section 28a can be controlled.

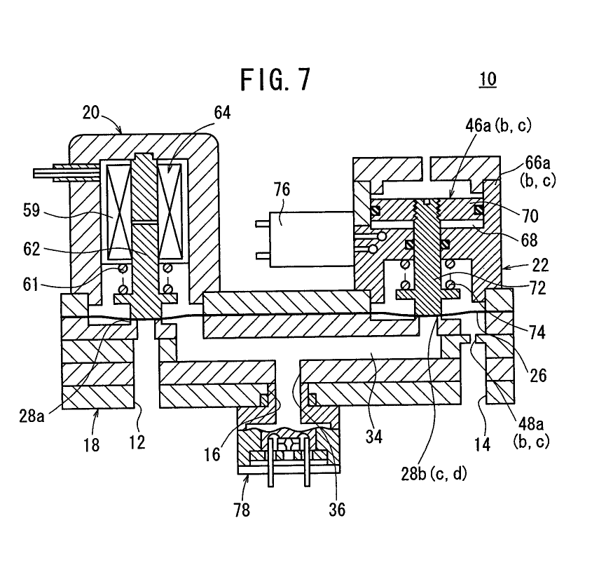

The control valve 21 of the pressure control section 20 is not limited to a piezoelectric/electrostrictive actuator having the piezoelectric/electrostrictive element 56 as described above. As shown in FIG. 7, a linear solenoid valve 64 may alternatively be provided, which generates an electromagnetic force in proportion to an amount of electric power applied to a solenoid section 59, so as to displace a valve rod 62 against the spring force of a spring member 61 by means of the generated electromagnetic force.

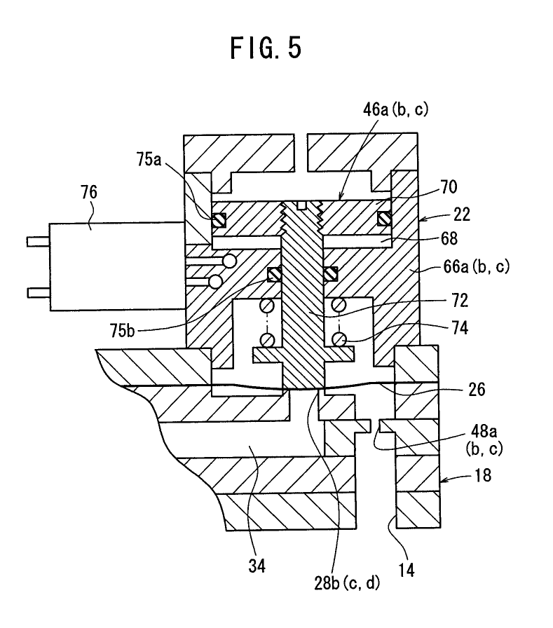

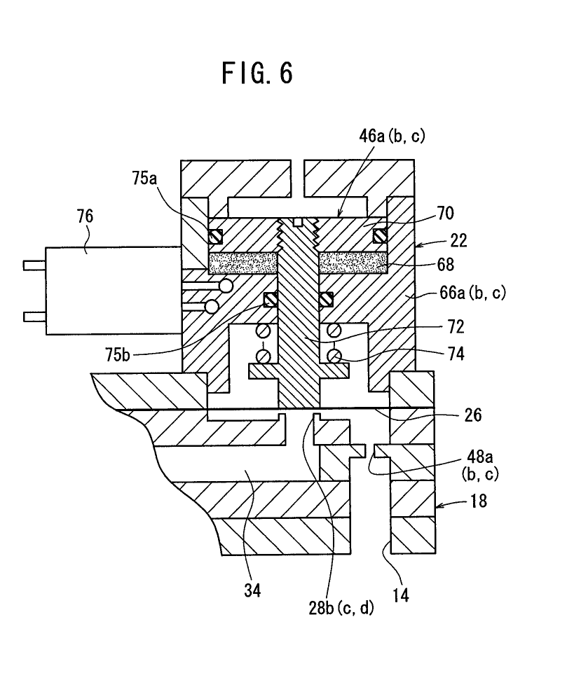

As shown in FIGS. 5 and 6, the flow passage-switching section 22 includes first to third ON/OFF valves 46a to 46c, provided with a plurality of housings 66a to 66c that are installed in other circular holes of the first plate 24a of the base section 18, pistons 70 accommodated within cylinder chambers 68 in the respective housings 66a to 66c, wherein the pistons 70 are displaceable in accordance with a pressing force of the pilot pressure supplied to the cylinder chambers 68, piston rods 72 connected to the pistons 70 and displaceable integrally with the pistons 70, and spring members 74, which are fastened onto the piston rods 72 and which urge the piston rods 72 such that the valve plugs 26 are seated on the seat sections 28b to 28d by continuously pressing the piston rods 72 downwardly by means of spring forces.

A first seal member 75a is installed in an annular groove formed on outer circumferential surfaces of each of the pistons 70. A second seal member 75b, surrounding the piston rod 72 is installed in an annular groove formed on an inner wall of the penetrating holes of the housings 66a to 66c through which the piston rods 72 are inserted (see FIGS. 5 and 6).

A solenoid-operated valve 76 additionally is provided in the flow passage-switching section 22. In particular, the solenoid-operated valve 76 is composed of a normally closed type, which is placed in an ON state under action of electric power applied to an unillustrated solenoid section, so as to supply a pilot pressure to the cylinder chamber 68.

Therefore, the supply of pilot pressure to the cylinder chamber 68 is stopped in an OFF state in which no current is supplied to the unillustrated solenoid section of the solenoid-operated valve 76. The forward end of the piston rod 72 presses the valve plug 26, which is composed of the diaphragm, toward the seat sections 28b to 28d by means of a spring force of the spring member 74. Accordingly, the first to third ON/OFF valves 46a to 46c are placed in a valve-closed state.

On the other hand, when electric power is applied to the unillustrated solenoid section of the solenoid-operated valve 76, then a pilot pressure is supplied to the cylinder chamber 68, whereupon the piston 70 is moved upwardly by means of a pressing action of the pilot pressure. In this situation, the piston rod 72 is moved upwardly integrally with the piston 70 in opposition to the spring force of the spring member 74. Accordingly, the valve plug 26, which is composed of the diaphragm, separates away from the seat sections 28b to 28d. Thus, the first to third ON/OFF valves 46a to 46c are placed in a valve-open state.

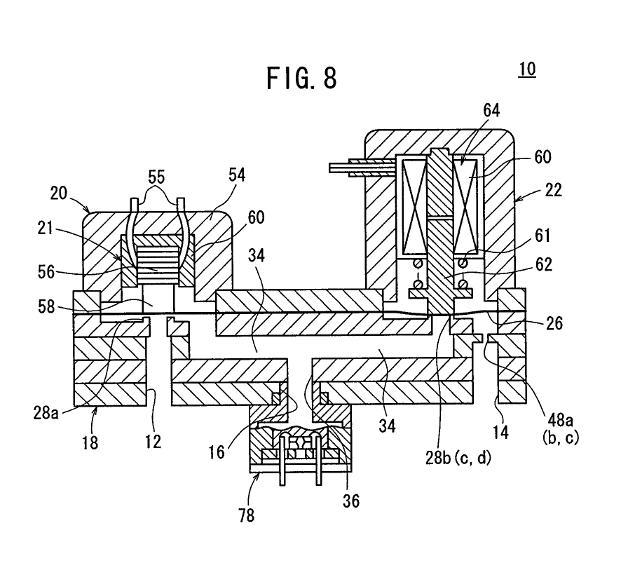

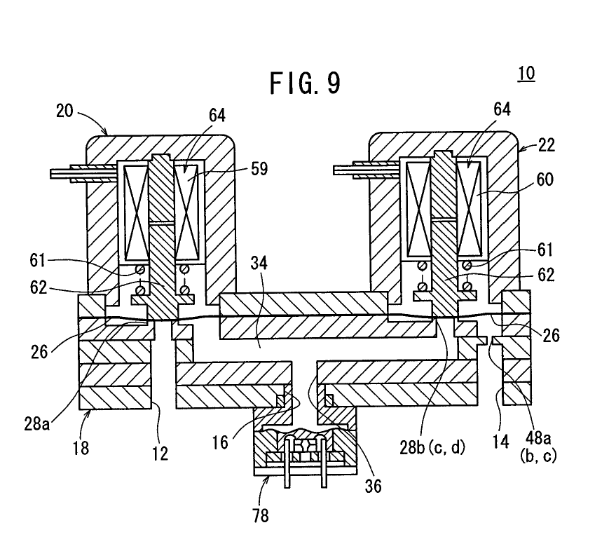

The arrangement of the flow passage-switching section 22 is not limited to a pilot type in which the solenoid-operated valve 76 is driven in order to introduce the pilot pressure. As shown in FIGS. 8 and 9, a linear solenoid valve 64 may also be provided, which generates an electromagnetic force in proportion to an amount of electric power applied to a solenoid section 59, so as to displace a valve rod 62 by means of electromagnetic force.

As shown in FIG. 1, the pressure sensor 78 is installed in the pressure sensor port 16, which is formed at a central portion of the lower surface of the base section 18. The pressure of the pressure fluid introduced from the pressure sensor port 16 is sensed by the pressure sensor 78. The pressure of the pressure fluid, which is sensed by the pressure sensor 78, is the pressure in the second passage 34, which is positioned on the upstream side of the first to third orifices 48a to 48c. The detection signal sensed by the pressure sensor 78 is supplied to the unillustrated controller.

The unillustrated controller performs calculation processing on the basis of the detection signal output from the pressure sensor 78 and data concerning the respective effective cross-sectional areas of the first to third orifices 48a to 48c, which are input beforehand. Accordingly, it is possible to highly accurately determine the flow rate of the pressure fluid emitted from the pressure fluid output port 14.

The flow rate control apparatus 10 according to the first embodiment of the present invention is basically constructed as described above. Next, operations, functions and effects thereof shall be explained.

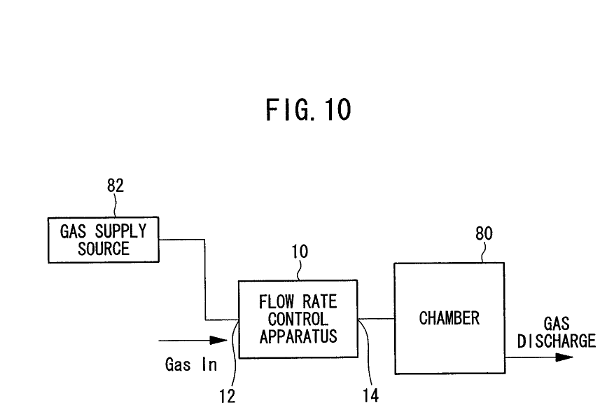

As shown in FIG. 10, the flow rate control apparatus 10 according to the first embodiment is arranged, for example, on the upstream side of a chamber 80 provided in a semiconductor manufacturing apparatus, and is used to supply gas at a predetermined flow rate into the chamber 80.

A gas supply source 82 is energized to introduce gas into the pressure control section 20 via the pressure fluid input port 12 and the first passage 30. In this situation, in the pressure control section 20, a predetermined voltage is applied to the piezoelectric/electrostrictive element 56 on the basis of a control signal derived from the unillustrated controller, in order to displace the piezoelectric/electrostrictive element 56 a predetermined length. Accordingly, the gap between the seat section 28a and the valve plug 26, which is composed of the diaphragm, is adjusted. The pressure of the gas that passes through the gap is maintained at a constant value.

The gas, which is pressure-regulated by the pressure control section 20, is introduced into the pressure sensor 78 via the pressure sensor port 16 and the third passage 36, which branches from an intermediate position of the second passage 34. The pressure value of the gas is input into the unillustrated controller via a detection signal, which is derived from the pressure sensor 78.

The gas, which is pressure-regulated by the pressure control section 20 as described above, is introduced into the flow passage-switching section 22 via the second passage 34. The gas passes through one or a plurality of ON/OFF valve or valves 46a (46b, 46c) in which the passages thereof open under action of electric power applied to the solenoid-operated valves 76 of the first to third ON/OFF valves 46a to 46c that make up the flow passage-switching section 22. Further, the gas is throttled by the orifice 48a (48b, 48c), which is disposed on the downstream side, so as to provide a predetermined flow rate. After that, the gas is emitted from the pressure fluid output port 14 via the seventh passage 44.

During this process, a control signal from an unillustrated controller is supplied to the solenoid-operated valve 76 in order to energize the predetermined solenoid-operated valve 76 in the flow passage-switching section 22. Accordingly, a pilot pressure is introduced into the cylinder chamber 68. The piston 70 and the piston rod 72 are moved upwardly under action of the pilot pressure. The valve plug 26, which is composed of the diaphragm, separates from the seat sections 28b to 28d, wherein any one of the first to third ON/OFF valves 46a to 46c is placed in an ON state (i.e., one or a plurality of the ON/OFF valves may be made available). Accordingly, a desired passage is opened in the fourth to sixth passages 38, 40, 42. The passage, through which gas is output from any one of the fourth to sixth passages 38, 40, 42, can be switched by energizing any one of the first to third ON/OFF valves 46a to 46c, so as to switch from an OFF state to an ON state, by means of the solenoid-operated valve 76 as described above.

As described above, when the pressure of the flowing gas is retained at a predetermined pressure by the pressure control section 20, the flow rate of the gas emitted from the pressure fluid output port 14 is calculated by an unillustrated controller, on the basis of the effective cross-sectional areas of the first to third orifices 48a to 48c through which the gas passes.

The gas emitted from the pressure fluid output port 14 is supplied into the chamber 80 of the semiconductor manufacturing apparatus.

In the embodiment of the present invention, the pressure control section 20, which regulates the pressure of the pressure fluid (for example, gas) that flows through the passage of the base section 18, the pressure sensor 78, which detects the pressure of the pressure-regulated pressure fluid, and the flow passage-switching section 22, which switches the flow passage for the pressure fluid while regulated to have a constant pressure, are integrally combined respectively on the upper surface of the stacked base section 18. Accordingly, unlike the conventional technique, it is unnecessary to perform matching operations for these components. Further, for example, even when the source pressure of the gas supply source 82 fluctuates, the flow rate of the pressure fluid still is controlled highly accurately, whereby it is possible to output the pressure fluid at a stable flow rate.

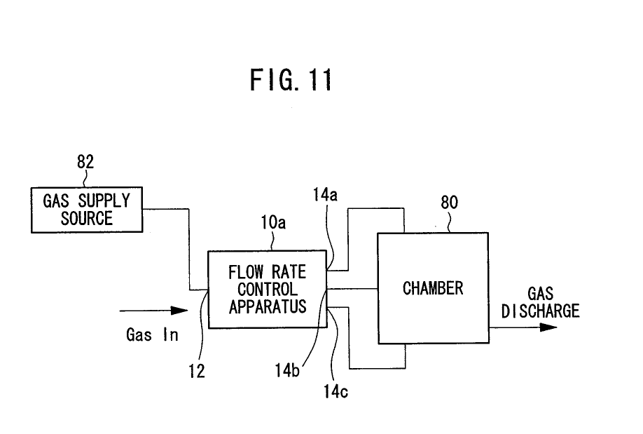

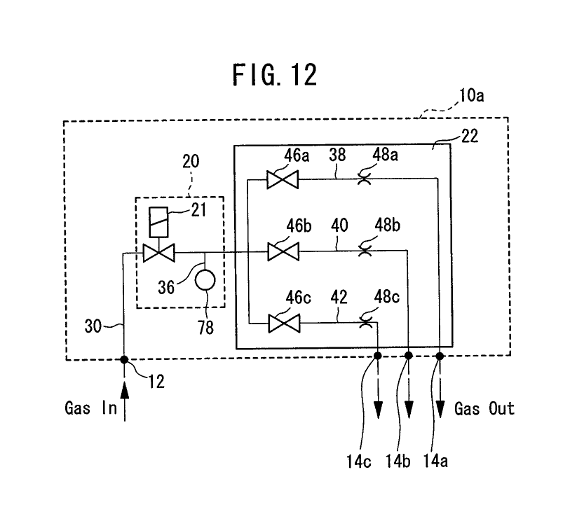

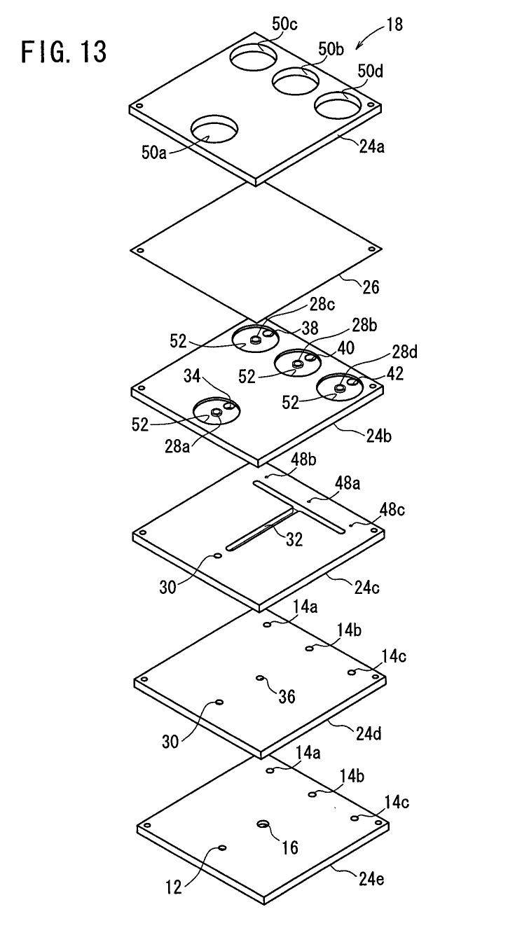

As shown in FIGS. 11 to 13, another flow rate control apparatus 10a may be provided in which the output is not made from a single pressure fluid output port 14 by merging the passages into a united passage after passage through the first to third orifices 48a to 48c. Rather, in the flow rate control apparatus 10a, the output branches in parallel, respectively, so as to be output simultaneously from the plurality of pressure fluid output ports 14a to 14c, or selectively from one or a plurality of the pressure fluid output ports.

As shown in FIG. 11, when the gas at a predetermined flow rate is simultaneously output from the plurality of pressure fluid output ports 14a to 14c, it is advantageous in that the gas can be supplied evenly and uniformly into the chamber 80, because the gas is supplied simultaneously in three directions into the chamber 80. For example, when the chamber 80 is separated into three sub-chambers by unillustrated partition walls, advantageously, the gas can be simultaneously supplied to the three separated sub-chambers.

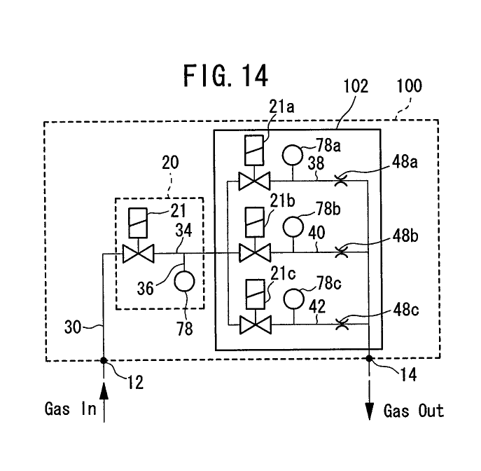

Next, a flow rate control apparatus 100 according to a second embodiment of the present invention is shown in FIG. 14. In the embodiment described below, constitutive components, which are the same as those of the first embodiment described above, shall be designated using the same reference numerals, and detailed explanations of such features shall be omitted.

The flow rate control apparatus 100 according to the second embodiment shown in FIG. 14 is different from the apparatus of the foregoing embodiment in that a flow passage-switching control section 102 is arranged in place of the flow passage-switching section 22. The flow passage-switching control section 102 uses the linear solenoid valves 64 described above, for example, as control valves 21a to 21c in place of the first to third ON/OFF valves 46a to 46c. In addition, other pressure sensors 78a to 78c are provided between the linear solenoid valves 64 and the first to third orifices 48a to 48c respectively.

In this arrangement, the other pressure sensors 78a to 78c are provided at lower portions of the stacked base section 18 in order to sense the pressure of the gas introduced via unillustrated passages disposed in the vertical direction and which communicate with the fourth to sixth passages 38, 40, 42 respectively. A predetermined flow rate is established on the basis of detection signals corresponding to pressure values supplied from each of the other pressure sensors 78a to 78c and the effective cross-sectional area of each of the first to third orifices 48a to 48c.

The reference pressure may be detected by the pressure sensor 78 provided in the pressure control section 20 disposed on the upstream side, whereas a pressure in the vicinity of the reference pressure may be detected accurately by the other pressure sensors 78a to 78c provided in the flow passage-switching control section 102.

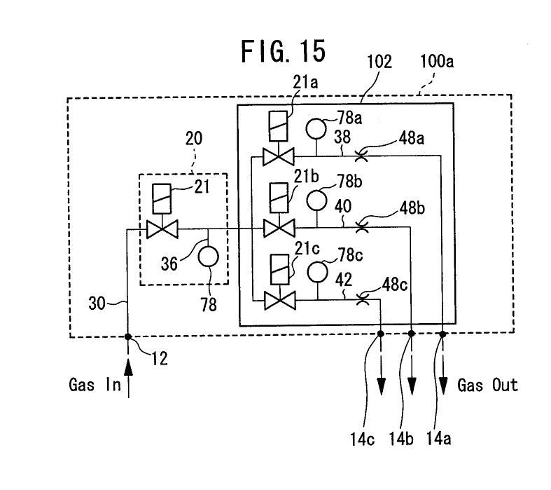

FIG. 15 shows a flow rate control apparatus 100a in accordance with a modified embodiment, in which the single pressure fluid output port 14 of the flow rate control apparatus 100 according to the second embodiment branches in parallel into three respective pressure fluid output ports 14a to 14c. Other arrangements, functions and effects are the same as those of the second embodiment, and therefore detailed explanations thereof shall be omitted.

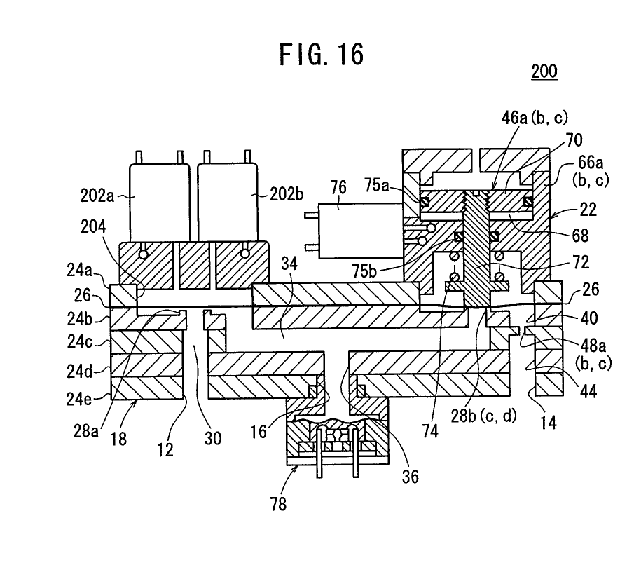

Next, a flow rate control apparatus 200 according to a third embodiment is shown in FIG. 16. The flow rate control apparatus 200 according to the third embodiment is characterized in that two solenoid-operated valves (ON/OFF valves) 202a, 202b, which make up a gas supply valve and a gas discharge valve, are subjected to ON/OFF operations respectively so as to function as control valves.

That is, the two solenoid-operated valves 202a, 202b, which function respectively as gas supply and discharge valves, are subjected to ON/OFF operations respectively on the basis of a control signal (pulse signal) provided from an unillustrated controller, in order to control the pilot pressure supplied to a space section 204 arranged with and disposed on an upper side of the diaphragm. Accordingly, the degree to which the valve is opened, which depends on the spacing distance between the valve plug 26 (diaphragm) and the seat section 28a, can be controlled highly accurately.

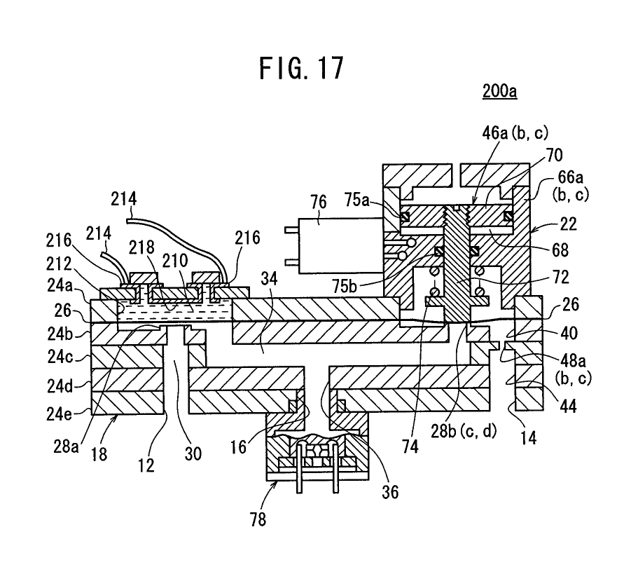

FIG. 17 shows a flow rate control apparatus 200a based on a modified embodiment, which carries a thermal expansion type actuator in place of the two solenoid-operated valves 202a, 202b.

In the flow rate control apparatus 200a, a cavity 212 enclosing a liquid 210 therein is disposed at an upper side of the diaphragm, which functions as the valve plug 26. A heater 218, to which electric power is applied via electrodes 216 connected to lead wires 214, is used to heat the liquid 210 so that the liquid 210 expands. Accordingly, the diaphragm is flexibly bent in order to control highly accurately the degree of the valve opening.

For the liquid 210, it is appropriate to use, for example, a liquid such as Fluorinert®, having an insulating property and an inert property, for the following reason. That is, owing to such a liquid, insulation can be maintained in relation to the electrodes 216, and the electrodes 216 can be protected against corrosion.

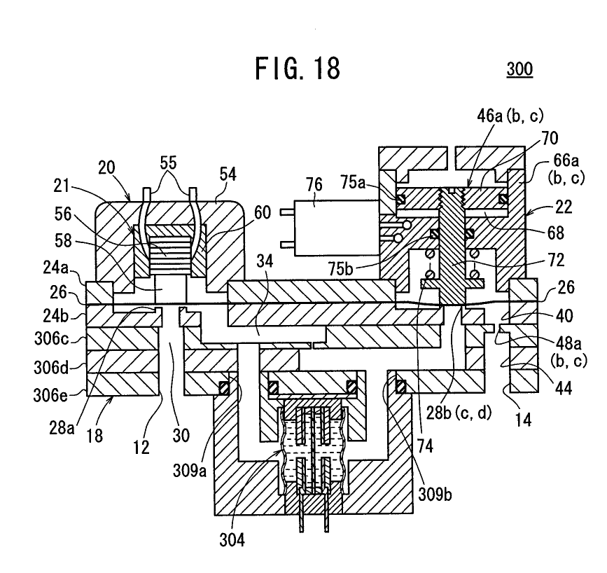

Next, a flow rate control apparatus 300 according to a fourth embodiment is shown in FIG. 18. The flow rate control apparatus 300 according to the fourth embodiment is characterized in that differential pressure sensors 304, each of which senses a differential pressure between upstream and downstream sides of an orifice 302 that functions as a throttle, are arranged in place of the pressure sensor 78 of the flow rate control apparatus 10 shown in FIG. 1. The flow rate is detected on the basis of the differential pressure, which is sensed by the differential pressure sensor 304.

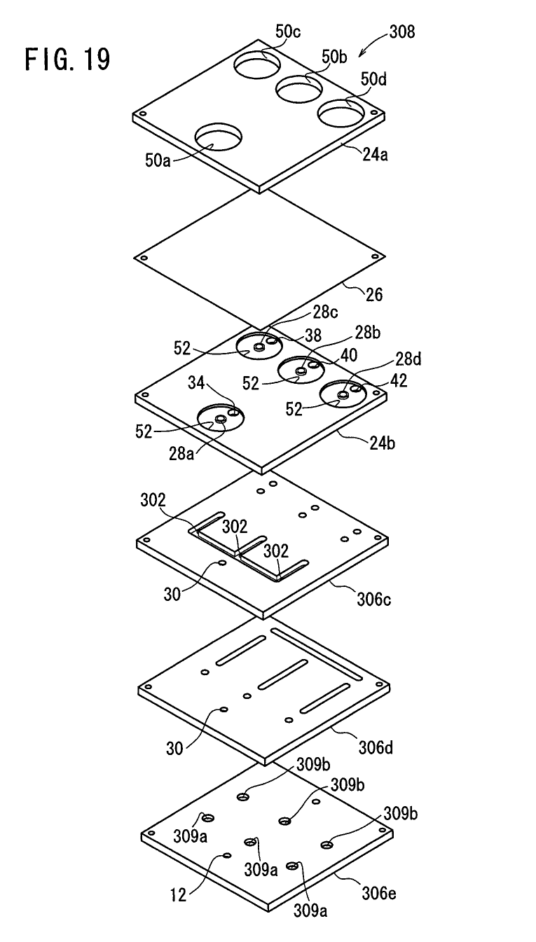

FIG. 19 shows a base section 308, which is formed by stacking first to fifth plates 24a, 24b, and 306c to 306e. A plurality of attachment ports 309a, 309b for the differential pressure sensors 304 are provided in the fifth plate 306e, which is disposed at the lowermost layer.

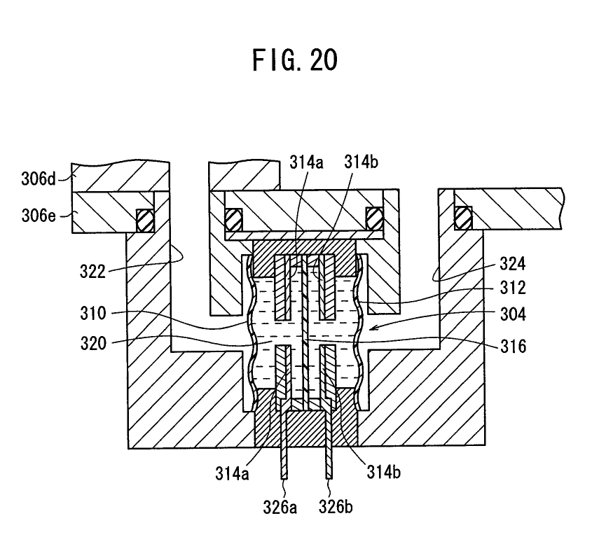

As shown in FIG. 20, the differential pressure sensor 304 includes a first pressure-receiving diaphragm 310 and a second pressure-receiving diaphragm 312, a pair of mutually opposed electrodes 314a, 314b arranged between the first pressure-receiving diaphragm 310 and the second pressure-receiving diaphragm 312, and an intermediate diaphragm (intermediate electrode) 316, which is flexibly bendable and arranged between the pair of electrodes 314a, 314b. Silicone oil 320 is enclosed within a space section 318, which is closed by the first pressure-receiving diaphragm 310 and the second pressure-receiving diaphragm 312 respectively.

In this arrangement, the pressure A of the pressure fluid introduced via the passage 322 that communicates with the upstream side of the orifice 302 acts on the first pressure-receiving diaphragm 310. On the other hand, the pressure B of the pressure fluid introduced via the passage 324 that communicates with the downstream side of the orifice 302 acts on the second pressure-receiving diaphragm 312.

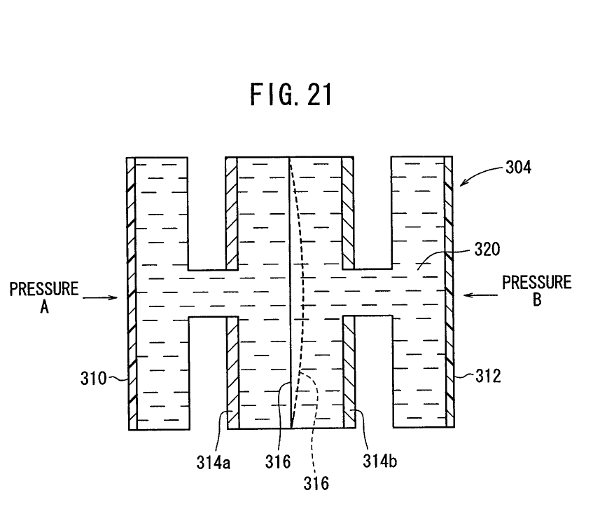

When the pressure A is higher than the pressure B (pressure A>pressure B), the intermediate diaphragm 316 is flexibly bent toward the second pressure-receiving diaphragm 312 in accordance with the amount of differential pressure, as shown by the broken line in FIG. 21. Therefore, the positional relationship between the pair of opposing electrodes 314a, 314b and the intermediate diaphragm 316, which functions as the intermediate electrode, changes. Further, the capacitance between the pair of electrodes 314a, 314b changes. The change in capacitance can be derived as a differential pressure signal from the output terminals 326a, 326b.

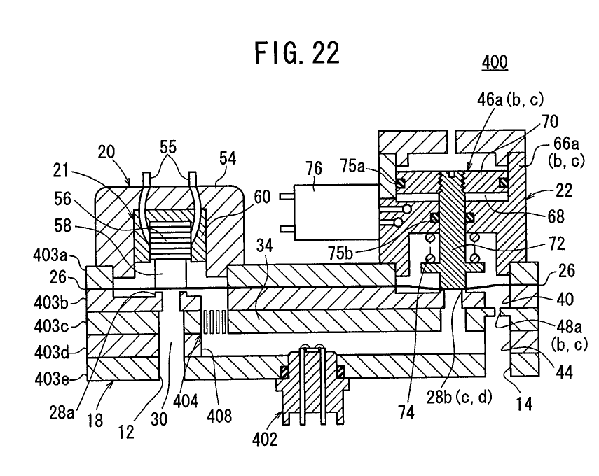

Next, a flow rate control apparatus 400 according to a fifth embodiment is shown in FIG. 22. The flow rate control apparatus 400 according to the fifth embodiment is characterized in that a flow rate sensor 402, which detects flow rate on the basis of a temperature change of a thermal wire provided on a silicon chip by means of MEMS (Micro-Electro-Mechanical Systems) technology, is arranged in place of the pressure sensor 78 of the flow rate control apparatus 10 shown in FIG. 1.

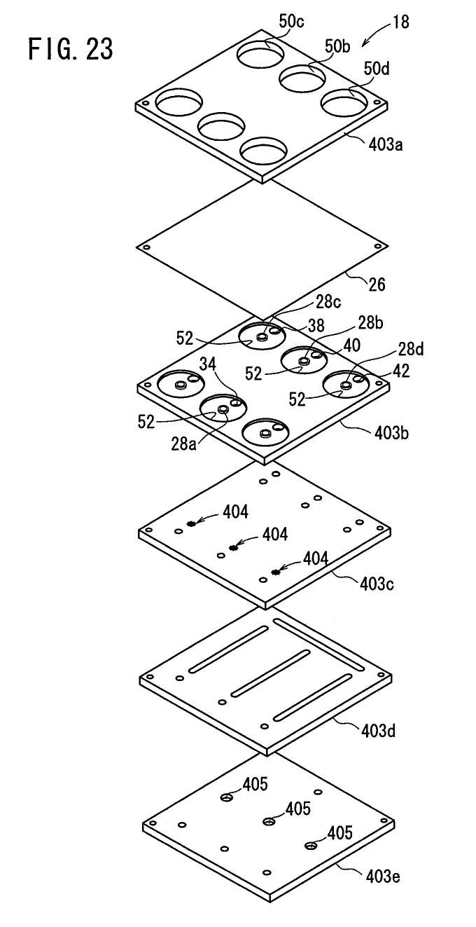

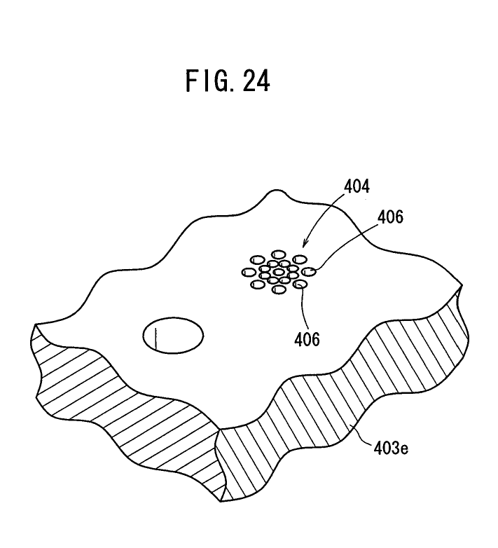

FIG. 23 shows a base section constructed by stacking first to fifth plates 403a to 403e. An intermediate third plate thereof is provided with rectifying mechanisms 404, each of which is composed of a plurality of small holes 406 having identical diameters and different diameters (see FIG. 24) respectively, to stabilize the flow of pressure fluid (gas) that flows through the passage, in order to obtain a stable signal in the flow rate sensor 402. The fifth plate 403e, which is disposed at the lowermost layer, is provided with sensor attachment ports 405 therein.

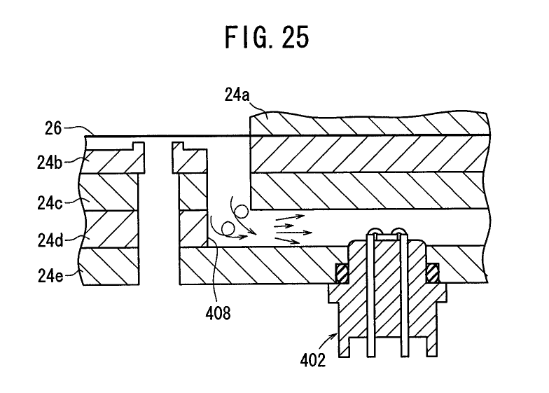

For example, as shown in FIG. 25, the gas that passes through the valve plug 26 flows into the flow rate sensor 402 via a flow passage, which is bent at substantially right angel or a certain angle. However, the flow velocity distribution becomes nonuniform at a bent section 408 of the flow passage, wherein the influence thereof is exerted on the piping portion to which the flow rate sensor 402 is attached as well. Hence, there is a concern that detection accuracy of the flow rate may be deteriorated. As a countermeasure, the straight piping portion ranging from the bent section 408 of the flow passage to the flow rate sensor 402 may be formed with a certain length in order to stabilize the flow velocity distribution. However, when this is done, a problem arises such that the product becomes large in size.

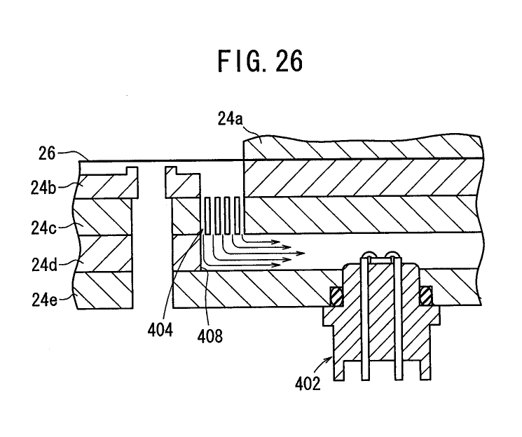

Accordingly, in order to miniaturize the product, as shown in FIG. 26, the rectifying mechanism 404 composed of a plurality of small holes 406 may be provided on an upstream side disposed closely to the bent section 408, so that the flow rate sensor 402 may be arranged at a position disposed relatively closely to the bent section 408 of the flow passage. The rectifying mechanism 404 provides a flow passage resistance in view of the shape, dimension and arrangement thereof, so that the flow velocity distribution is stabilized even after passage through the bent section 408 of the flow passage. The flow passage resistance of the rectifying mechanism 404 is provided in order to change the flow velocity distribution within the tubular passage. It is also desirable that pressure loss be decreased so as to be as small as possible within the entire rectifying mechanism 404.

While the invention has been particularly shown and described with reference to preferred embodiments, it will be understood that variations and modifications can be effected thereto by those skilled in the art without departing from the spirit and scope of the invention as defined by the appended claims.

What is claimed is:

1. A flow rate control apparatus comprising:
a base section having pressure fluid passages composed of penetrating or non-penetrating holes, a pressure fluid input port, a pressure fluid output port, and a pressure sensor port, said base section being formed by integrally stacking a plurality of plates and a diaphragm that functions as a valve plug disposed between said plates;
a pressure control section assembled onto a side surface of said base section, which regulates a pressure of a pressure fluid that flows through said passages;
a pressure sensor assembled onto said side surface of said base section, which communicates with said pressure sensor port and which detects said pressure of said pressure fluid that flows through said passages; and
a flow passage-switching section assembled onto said side surface of said base section, which switches said passages that communicate with said pressure control section and said pressure fluid output port so that said pressure fluid that is pressure-regulated by said pressure control section, flows toward said pressure fluid output port.

2. The flow rate control apparatus according to claim 1, wherein said pressure control section comprises a piezoelectric/electrostrictive actuator having a piezoelectric/electrostrictive element, said base section being formed with a seat section for seating said valve plug thereon, and wherein a spacing distance between said valve plug and said seat section is controlled under a driving action of said piezoelectric/electrostrictive actuator.

3. The flow rate control apparatus according to claim 1, wherein said pressure control section comprises a linear solenoid valve for displacing a valve rod by means of an electromagnetic force generated in proportion to an amount of electric power applied to a solenoid section, said base section being formed with a seat section for seating said valve plug thereon, and wherein a spacing distance between said valve plug and said seat section is controlled under a driving action of said linear solenoid valve.

4. The flow rate control apparatus according to claim 1, wherein said flow passage-switching section comprises an ON/OFF valve having a piston that is displaceable on the basis of a pilot pressure supplied under an energizing/deenergizing action of a solenoid-operated valve, and a piston rod that is displaceable integrally with said piston, said base section being formed with a seat section for seating said valve plug thereon, and wherein said passage through which said pressure fluid flows is opened and closed in accordance with an ON/OFF operation of said ON/OFF valve.

5. The flow rate control apparatus according to claim 1, wherein said base section includes said pressure fluid output port or a plurality of pressure fluid output ports.

6. A flow rate control apparatus comprising:
a base section having pressure fluid passages composed of penetrating or non-penetrating holes, a pressure fluid input port, a pressure fluid output port, and a pressure sensor port, said base section being formed by integrally stacking a plurality of plates and a diaphragm that functions as a valve plug disposed between said plates;
a pressure control section assembled onto a side surface of said base section, which regulates a pressure of a pressure fluid that flows through said passages;
a pressure sensor assembled onto said side surface of said base section, which communicates with said pressure sensor port and which detects said pressure of said pressure fluid that flows through said passages; and
a flow passage-switching control section assembled onto said side surface of said base section, which includes control valves for controlling said pressure fluid that is pressure-regulated by said pressure control section so that said pressure fluid has a predetermined flow rate, other pressure sensors for detecting pressures of said pressure fluid that passes through said control valves, and throttle mechanisms for throttling said pressure fluid that is pressure-regulated by said control valves, so that said pressure fluid has a predetermined flow rate, wherein said flow passage-switching control section switches and controls said passages that communicate with said pressure fluid output port.

7. The flow rate control apparatus according to claim 6, wherein each of said control valves comprises a linear solenoid valve for displacing a valve rod by means of an electromagnetic force generated in proportion to an amount of electric power applied to a solenoid section.

8. The flow rate control apparatus according to claim 6, wherein each of said control valves comprises a pair of solenoid-operated valves functioning as gas supply and discharge valves.

9. The flow rate control apparatus according to claim 6, wherein:
each of said control valves comprises a thermal expansion type actuator; and
said thermal expansion type actuator comprises a cavity, which encloses a liquid therein, disposed on an upper side of said diaphragm, so that said diaphragm is flexibly bent when said liquid is expanded by heating said liquid with a heater.

10. The flow rate control apparatus according to claim 9, wherein said liquid is composed of a liquid having an insulating property and an inert property.

11. A flow rate control apparatus comprising:
a base section having pressure fluid passages composed of penetrating or non-penetrating holes, a pressure fluid input port, a pressure fluid output port, and a pressure sensor port, said base section being formed by integrally stacking a plurality of plates and a diaphragm that functions as a valve plug disposed between said plates;
a pressure control section assembled onto a side surface of said base section, which regulates a pressure of a pressure fluid that flows through said passages;
a flow rate sensor assembled onto said side surface of said base section, which detects a flow rate of said pressure fluid that flows through said passages,
wherein an intermediate plate, which is included in the plurality of plates making up said base section, is provided with rectifying mechanisms therein composed of a plurality of small holes having identical and different diameters, for stabilizing a flow of said pressure fluid that flows through said passages.
